(19) United States
(12) Patent Application Publication
(10) Pub. No.: US 2009/0281864 A1
(43) Pub. Date: Nov. 12, 2009

(54) SYSTEM AND METHOD FOR IMPLEMENTING AND MONITORING A CYBERSPACE SECURITY ECONOMETRICS SYSTEM AND OTHER COMPLEX SYSTEMS

(76) Inventors: Robert K. Abercrombie, Knoxville, TN (US); Frederick T. Sheldon, Knoxville, TN (US); Ali Mili, Phillipsburg, NJ (US)

Correspondence Address: UT-Battelle/Chicago/BHGL, P.O. Box 10395, Chicago, IL, 60610, US

(21) Appl. No.: 12/421,933

(22) Filed: Apr. 10, 2009

Related U.S. Application Data
(60) Provisional application No. 61/052,556, filed on May 12, 2008.

(51) Int. Cl. G06Q 10/00; G06Q 50/00

(52) U.S. Cl. 705/8; 705/7

(57) ABSTRACT

A device of implementing an econometrics-based control system. The device includes a processor, a memory in communication with the processor and configured to store processor implementable instructions. The processor implementable instructions are programmed to correlate a plurality of system requirements with each of a plurality of system stakeholders, identify a stake relating to each of the plurality of system stakeholders and the correlated plurality of system requirements such that the stake is identified by each of the plurality of system stakeholders, determining a mean failure cost as a function of the identified stake and a failure probability, and analyzing the mean failure cost to determine a control strategy. The device may further comprise a communication component in communication with the processor and the memory, the communication component configured to communicate the control strategy to a component operable within the control system such that the component implements the control strategy.

### CROSS-REFERENCE TO RELATED APPLICATION

This patent claims the priority benefit under 35 U.S.C. §119(e) of U.S. provisional patent application Ser. No. 61/052,556, titled “SYSTEM AND METHOD FOR IMPLEMENTING AND MONITORING A CYBERSPACE SECURITY ECONOMETRICS SYSTEM AND OTHER COMPLEX SYSTEMS,” filed on May 12, 2008, the entire contents of which is hereby incorporated by reference.

### STATEMENT REGARDING FEDERALLY SPONSORED RESEARCH OF DEVELOPMENT

This invention was made with government support under Contract No. DE-AC05-00OR22725 awarded by the U.S. Department of Energy. The government has certain rights in the invention.

### BACKGROUND

Mean-Time-To-Failure (MTTF) is generally considered to represent the basic reliability of a complex and/or non-repairable system. In particular, MTTF represents the mean time expected until the first failure of a piece of equipment, a system, a complex device, computer network or subsystem, etc. Mathematically, MTTF is assumed to apply to a statistically large number of units, elements, networks or systems over a statistically significant period of time.

MTTF generally assumes that the each of the elements, components, subsystems, etc. of a given system of interest is of equal importance or criticality to each of the users and/or stakeholders of the system. In other words, MTTF assumes that each of the elements, components, subsystems are equally critical to a system's operation, and that individual stakeholders or users of the system have an equal interest in the operation of each of the elements, components, subsystems.

### SUMMARY

It would be desirable to provide a metric, measurement, statistic or indication of the reliability, performance and/or safety (to include security) of a system that accounts for the criticality of each requirement as a function of one or more stakeholders interests in that requirement. Mean-Failure-Cost (MFC) quantifies the impact of failures, interruptions, etc. as a function of failure cost per unit of time. The possible impact of a failure may, in turn, be evaluated against the potential benefit of continuing to operate the system for the same unit of time and/or the potential cost of attempting to mitigate the possible impact of the failure in order to determine the desirability of continuing to operate the system. MFC metrics or measurements support value based decision making by allowing the potential costs to be apportioned or identified in conjunction with one or more individual stakeholders of the system. Moreover, MFC metrics and methodology provide a way to integrate reliability, safety and security in a unified model. In particular, MFC methodology makes no distinction between reliability and safety, as it supports a continuum of failure costs, from the mundane to the critical; hence MFC integrates safety seamlessly with reliability.

In one embodiment, a device for implementing an econometrics-based control system is disclosed. The device includes a processor, a memory in communication with the processor and configured to store processor implementable instructions. The processor implementable instructions are programmed to correlate a plurality of system requirements with each of a plurality of system stakeholders, identify a stake relating to each of the plurality of system stakeholders and the correlated plurality of system requirements such that the stake is identified by each of the plurality of system stakeholders, determining a mean failure cost as a function of the identified stake and a failure probability (e.g., the term failure probability can be utilized interchangeably with the tern “failure rate”), and analyzing the mean failure cost to determine a control strategy. The device may further comprise a communication component in communication with the processor and the memory, the communication component configured to communicate the control strategy to a component operable within the control system such that the component implements the control strategy.

In another embodiment, a method of implementing an econometrics-based control system is disclosed. The method includes identifying a plurality of system requirements, identifying a plurality of system stakeholders, defining a stake related to the interest of each of the plurality of system stakeholders in one of the plurality of system requirements, correlating the plurality of system requirements with each of the plurality of system stakeholders, assigning a failure probability to each of the identified plurality of system requirements, determining a mean failure cost as a function of the identified stake and the failure probability, analyzing the mean failure cost to determine a control strategy, and communicating the control strategy to a component operable within the control system, wherein the component implements the control strategy.

Other embodiments are disclosed, and each of the embodiments can be used alone or together in combination. Additional features and advantages of the disclosed embodiments are described in, and will be apparent from, the following Detailed Description and the figures.

### BRIEF DESCRIPTION OF THE FIGURES

FIG. 1 illustrates an embodiment of a network that may be implemented according to the disclosure provided herein;

FIG. 2 illustrates an embodiment of a network device or element that may be utilized in connection with the network shown in FIG. 1;

FIG. 3 illustrates a device for use in implementing and monitoring the components, devices and network according to the disclosure provided herein; and

FIG. 4 illustrates an algorithm for defining and/or implementing an MFC-based control system according to the disclosure provided herein; and

FIG. 5 illustrates an exemplary network or system that may be analyzed utilizing an MFC-based control scheme according to the disclosure provided herein.

### DETAILED DESCRIPTION

Complex systems configured to serve, service or otherwise interact with a variety of parties or stakeholders may be, due to constraints in time, money and/or other business reasons, designed to balance a number of design constraints and/or requirements in an attempt to address and provide the maximum reliability in the form of the service or interactions provided to the variety of parties and/or stakeholders.

### I. Conceptual Basis of Mean Failure Cost

Implementing a control system that provides effective security measures for a complex system may require the use of reliable and/or effective security metrics and/or measurements. Security metrics and measurements may further be utilized to design security countermeasures, to select or identify alternative security architectures, and to improve and/or monitor security in real-time during operation of the system. Characteristic or qualities of an effective security metric may include but are not limited to: (1) ability to identify and measure properties necessary for decision making; (2) measurable in a quantitative manner; (3) capable of accurate and repeatable measurement; (4) independently verifiable via an outside datum or reference; and (5) able to provide or enhance the confidence level in the overall metric.

Additional characteristics or qualities of effective security metrics or measurements may include: (A) inexpensive, as a function of time and/or cost, to gather and/or determine; (B) can be independently refereed or audited (in terms of compliance, accreditation and certification); and (C) scalable between individual devices and computers to multiple devices and computers within an enterprise scale network.

Mean-Failure-Cost (MFC) embodies many/all of the characteristics of an effective security metric and may be utilized to quantify the impact of failures, interruptions, etc. as a function of failure cost per unit of time. Moreover, MFC may be utilized to determine and illustrate how much each stakeholder in a complex system stands to lose as a result of, for example, a security failure, a hardware failure or any other service disruption.

MFC may be utilized within the framework provided by a Cyberspace Security Econometrics System (CSES) to design, implement and control a complex system. CSES provides many advantages over other known measurement or analysis systems or methodologies such as: (1) it reflects variances existing between different users or stakeholders of the system. Different stakeholders may attach different stakes to the same requirement or service (e.g., a service may be provided by an information technology system, cyber, enterprise or process control system, etc.). (2) For a given stakeholder, CSES can highlight variances that may exist among the stakes attached to satisfying each requirement. For example, a stakeholder may attach or identify different stakes to satisfying different requirements within the overall system. (3) For a given compound specification (e.g., combination(s) of commercial off the shelf software and/or hardware), CSES can identify variances that may exist amongst the levels of verification and validation (V&V) that are performed on components of the specification. The verification activity may produce higher levels of assurance in satisfying some components of the specification than others.

The methodology, algorithm and/or analytical framework disclosed herein may be embodied by a CSES and utilized to design, control, and monitor one or more key attributes associated with the system. For example, the attributes, requirements, etc. may support the decisions relating to (A) the design of security countermeasures, (B) the choice between alternative security architectures and responses to events such as intrusions or attacks and (C) the improvement of security (including reliability and safety) during both design and operations.

One example of a CSES, which is based on MFC, may be employed to determine and ensure that the cost of any verification and validation (V&V) effort is charged on the users and stakeholders according to what they stand to gain from the adjustment, change, and/or higher level of assurance, etc. This user or stakeholder based approach replaces traditional V&V schemes where effort is charged uniformly to each of the users or stakeholders regardless of the benefit derived with respect to each user or stakeholder. Hence if a particular V&V effort is aimed at improving the level of confidence that refines a component, device (i.e., that implements a service and or satisfies a requirement) operating within a given system, then the users or stakeholders are charged according to the stake they have in satisfying said requirement. Verification costs may further be considered to account for the possibility that one or more of the requirements of the system may be easier to verify than another requirement or component. Such costs depend on the requirement and the selected verification method or system.

### II. Mean Failure Cost (MFC) as a Metric of Security

MFC (Mean Failure Cost) quantifies, in terms of dollars per unit of time (e.g. dollars per hour of system operation), the average loss or cost due to security threats. MFC may be utilized as a quantitative economic function, similar to Value Based Software Engineering (VBSE), to estimate the robustness of the system by matching the system's operational value against its mean failure cost. MFC, unlike other known analysis tools, accounts for variations between different stakeholder in the system by reflecting the difference in stakes that each stakeholder has in the operation of various components or devices comprising the system. Similarly, MFC accounts for variations between different components/subsystems by reflecting the difference in security attributes of these components/subsystems resulting from different levels of V&V against the specified security target.

MFC, in an exemplary Cyber Security Econometrics System (CSES), may be determined according to, for example, a four steps methodology that includes: (A) generation of stake matrix; (B) generation of a dependency matrix, (C) generation of a threat matrix and (D) generation of a mitigation costs matrix.

A. Stakes Matrix: Stakeholder V. Requirements:

Generation of the stakes matrix begins with (1) identifying stakeholders in the system and (2) identifying the security specifications and thus the security requirements associated with the system. For each stakeholder and each security requirement of the system, a stake may be identified which corresponds to the stakeholders interest in a particular security specification and/or security requirement. The stake may correspond to a cost that a particular stakeholder may incur due to the failure to satisfy the particular security specifications and/or security requirements associated therewith. Stake information may be provided, quantified and/or otherwise identified by the stakeholder themselves.

Estimation or derivation of an MFC metric depends on the premises that the same stakeholder may have different stakes in different security requirements, and that the same security requirement may carry different stakes for different stakeholders. One representation may be a two dimensional matrix, where the rows represent individual stakeholders, the columns represent discrete security requirements and the entries represent stakes, as shown below in Table 1.

TABLE 1
The stakes matrix showing how Failure Cost (FC) is derived.

| | | SECURITY REQUIREMENTS | | | | |
|---|---|---|---|---|---|---|
| STAKES MATRIX | | R₁ | R₂ | R₃ | . . . | Rₙ |
| STAKEHOLDERS | S₁ | | | | | |
| | S₂ | | | | | |
| | S₃ | | | | | |
| | . . . | | | | FCᵢ^{j} | |
| | Sₘ | | | | | |

The failure cost (FC) entry at row i, column j, represents the cost that user or stakeholder Sᵢ would lose if the system failed to meet the security requirement Rⱼ (i.e., also represented as FC(Sᵢ,Rⱼ)). Table 1 is determined by users or stakeholders. Each row is filled by the corresponding stakeholder, possibly in their own (possibly distinct) financial/economic terms (Dollars, Person Months, Euros, etc).

The stakes matrix provides a way to estimate MFC associated with a stakeholder Sᵢ utilizing the formula:

$$M F C ( S ) = {\sum }_{{R}_{i}} P ( {R}_{i} ) \times F C ( S , {R}_{i} ) ,$$

where P(Rᵢ) represents the probability that the system fails to meet requirement Rᵢ. Stated another way, the MFC for a stakeholder S is the sum, for all requirements (Rᵢ), of the failure costs associated with these requirements weighted or adjusted by the probability of failing them. The stakes matrix may be utilized to determine the terms FC(S,Rᵢ), while a Dependency matrix may be utilized to determine the probability (P) terms.

B. Dependancy Matrix: Requirements V. Components

A dependency matrix may be utilized to estimate the probability that one of the identified security specifications is not satisfied and/or that one of the identified security requirements (Rᵢ) is violated during a period of time. The dependency matrix, as shown in Table 2, links the probability of failing to provide or satisfy requirement (Rᵢ) with the probability of a component or device failure within the system. The identification of the link between the failure to satisfy requirement (Rᵢ) and the probability of a components failure may require an analysis of the system architecture to determine the contribution of each component to a given requirement.

TABLE 2
The dependency matrix linking requirement with components.

| | | COMPONENTS | | | | |
|---|---|---|---|---|---|---|
| DEPENDENCY MATRIX | | C₁ | C₂ | C₃ | . . . | Cₖ |
| REQUIREMENTS | R₁ | | | | | |
| | R₂ | | | | | |
| | R₃ | | | | | |
| | . . . | | | | π(Rᵢ\|Eⱼ) | |
| | Rₙ | | | | | |

The dependency matrix illustrates the relationship between requirements and their respective components and failure results. Stated another way, the Dependency matrix provides a way to estimate the probability that the system fails to meet requirement Rᵢ is the sum for all of the failure Events j related to component Cᵢ utilizing the formula:

$$P ( R ) = {\sum }_{i = 1}^{k + 1} π ( {E}_{i} ) \times π ( R \vert {E}_{i} ) ,$$

where (as shown in Table 2) C₁, C₂, C₃ . . . Cₖ are components of the system the term Eᵢ represents the Failure of Component Cᵢ event, and Eₖ₊₁ represents the No Component has Failed event (or non-event). The term π(Eᵢ) represents the probability of event Eᵢ and the term π(R|Eᵢ) represents the probability of a failure to satisfy requirement R represents given the hypothesis Eᵢ (e.g., that the event i (Eᵢ) has occurred.) In general, it may be assumed that in the absence of component failures, security requirements are vacuously satisfied and may be represented by the expression:

π(R|Eₖ₊₁)=0

C. Impact Matrix: Component Failure V. Threats

Generation or construction of an impact matrix to determine the probability of component failure may depend on the evaluation of a number of factors such as, for example: (1) the protection (e.g., the armor, the technical controls, the fallback strategies, and other known V&V strategies and tools) afforded components against threats and/or failures or which provide redundancy against a successful threat or attack. (2) The pattern of threats or attacks to which the component may be subjected. This may include defining or establishing one or more threat models to catalog what threats or families of threats against which protection may be required. An example of threat classifications that may be incorporated into the threat model includes: insider threats; intrusions (including malware, break-ins, spoofing, phishing and other social engineering methods); denial of service threats; authentication threats; and other known and/or foreseeable threats. (3) The degree to which a given component has undergone verification and validation (V&V) through testing, inspection, static analysis, etc.

To assess the likelihood that a particular threat within the threat model may result in the failure of the component Cₖ, we may consider a set of cataloged threats (or families of threats with common attributes), say T₁, T₂, T₃, . . . Tₕ, and we may consider the events V₁, V₂, V₃, . . . Vₕ, Vₕ₊₁, where Vᵢ, for 1≦i≦h, stands for: Threat i has materialized, and Vₕ₊₁ stands for: No threat i has materialized. Because events Vᵢ, for 1≦i≦h+1, are complementary (if we assume that no more than one threat materializes at a time), we can utilize the formula:

$$π ( {E}_{i} ) = {\sum }_{j = 1}^{h + 1} π ( {V}_{j} ) \times π ( {E}_{i} \vert {V}_{j} ) ,$$

to link the probability of threat Tⱼ(which is π(Vⱼ)) to the probability of a failure of component Cᵢ (which is π(Eᵢ)). The conditional probabilities between the Threats and the Component may be derived utilizing the impact matrix illustrated in Table 3.

TABLE 3
The impact matrix showing component failure versus threats
relationship grouping

| | | THREATS | | | | |
|---|---|---|---|---|---|---|
| IMPACT MATRIX | | T₁ | T₂ | T₃ | . . . | Tₕ |
| COMPONENTS | C₁ | | | | | |
| | C₂ | | | | | |
| | C₃ | | | | | |
| | . . . | | | | π(Eᵢ\|Vⱼ) | |
| | Cₖ | | | | | |

The impact matrix may be filled by component analysts and security experts or other means that may assess the impact that each type of threat may have on the operation of a given component. In other embodiments, automated mechanisms such as, for example, a Common Vulnerability Scoring System (CVSS), or manual mechanisms such as, for example, Subject Matter Experts (SMEs) may be utilized.

In this way, the probability of failing a requirement is obtained by the sum, for all components, of the conditional probabilities of failing that requirement, conditional on failure of the component, weighted by the probability of failure of the component.

D. Mitigation Costs Matrix

Generation of a mitigation costs matrix provides an exemplary mechanism and methodology by which mitigation costs associated with a potential threat, as well as failure costs, may be addressed and encompassed by the MFC metric. In particular, the dependency Dⱼ can be quantified by correlating, as shown in Table 4, the failure of a component within the system with the failure to provide a service or satisfy a requirement.

TABLE 4
Mitigation cost matrix linking service/requirement and
component mitigation costs

| MITIGATION | | | | | | | | |
|---|---|---|---|---|---|---|---|---|
| COST | | COMPONENTS | | | | | | |
| MATRIX | | C₁ | C₂ | C₃ | C₄ | C₅ | | |
| SERV- | S₁ | | | | | | Verification | VS₁ |
| ICES | S₂ | | | | | | Cost by | VS₂ |
| | S₃ | | | | | | Service | VS₃ |
| | S₄ | | | | Dᵢ^{j} | | | VS₄ |
| | S₅ | | | | | | | VS₅ |

| Verification Cost by | | | | |
|---|---|---|---|---|
| Component | | | | |
| VC₁ | VC₂ | VC₃ | VC₄ | VC₅ |

The dependency Dᵢ^{j} can be combined with the cost of verifying each of the components that, in turn, can be utilized to estimate of the probability of service delivery as a function of the effort invested to enhance the robustness of the component. This estimate may be utilized, discretely and in real-time, to identify and prioritize which components to enhance, upgrade or otherwise service. The estimate may further be utilized to determine an amount to charge a given stakeholder as a function of their derived benefit according to the formula:

$${VS}_{i} = {\sum }_{j = 1}^{n} {D}_{i}^{j} \times {VC}_{j} .$$

### III. Results Analysis and Implementation

Analysis of the above-defined results may be summarized as the vector of mean failure costs (MFC, one entry per stakeholder) as defined by the following equation:

MFC=ST∘PR,

where ST is the stakes matrix and PR is the vector of requirement failure probabilities (one entry per requirement).

The vector of requirement failure probabilities is given by the following equation:

PR=DP∘PE,

where DP is the dependability matrix and PE is the vector of component failure probabilities (one entry per component).

The vector of component failure probabilities is given by the following equation:

PE=IM∘PV,

where IM is the impact matrix and PV is the vector of threat emergence probabilities (one entry by type of threat).

By substitution, we find the equation that gives us vector of mean failure costs of all stakeholders as:

MFC=ST∘DP∘IM∘PV,

where vector PV represents the probability of emergence of the various threats that are under consideration. This probability may be provided by any one of the system users, architects and other experts or users, or it may be determined empirically, by simulating and/or operating the system for some length of time and estimating the number of threats that emerge during that time and may be refined continuously as the system evolves.

All of this information may, in turn, be utilized to identify potential weaknesses within a given system and allow the user or stakeholder to determine the cost benefit of addressing each weakness with respect to their given mission or objectives. The information may further be utilized to address or generate a control strategy for implementation within the system, the control strategy may serve to minimize the identified weaknesses in a cost effective manner.

### IV. Exemplary Implementation of a CSES

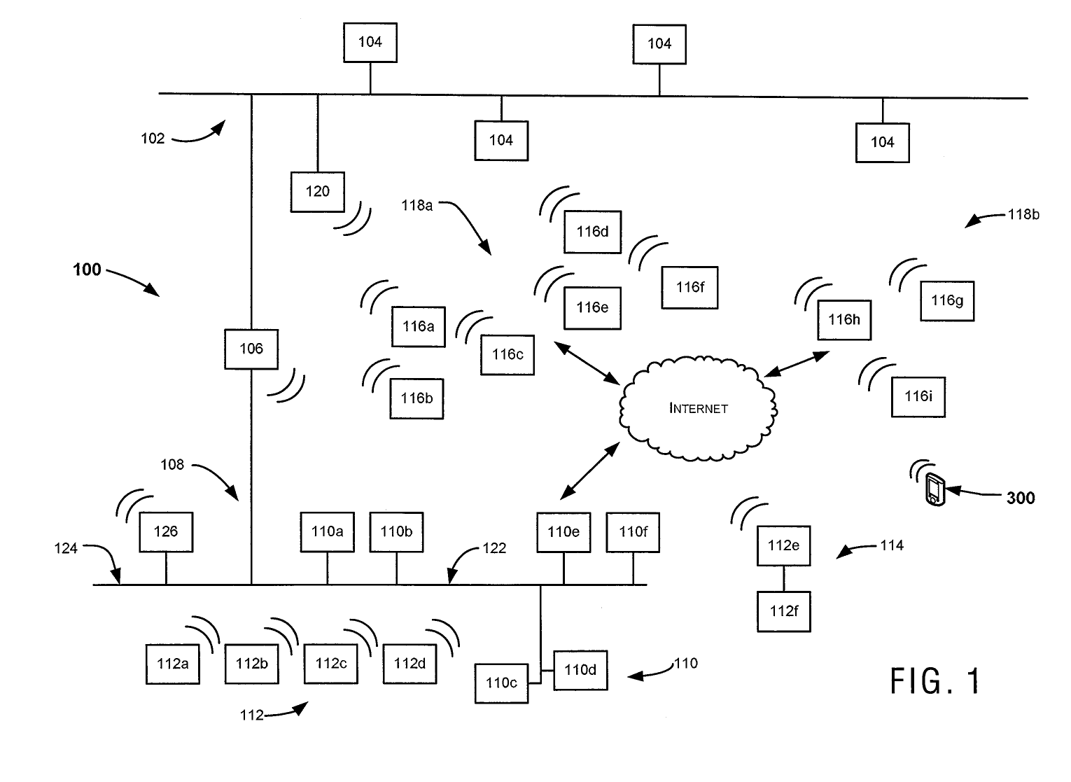

FIG. 1 illustrates an exemplary network 100 that may incorporate the methods, systems and teaching provided herein. The network 100 may includes a first network 102 in communication with one or more controllers such as a plurality of terminals 104 and a router 106. The router 106 may couple the first network 102 to a second network 108. The first network 102 may be wired or wirelessly coupled or in communication with the second network 108. The second network 108, in this exemplary embodiment, may include a first wired network portion 122 and a second wired network portion 124 that connect to network elements or devices 110 (individually identified as network elements or devices 110a to 110f). The second wired network portion 124 may be coupled to network elements or devices 112 via a wireless device 126. For example, the network elements or devices 112 may include wireless devices individually identified as devices 112a to 112f. In one embodiment, the device 112f may be a wired device, that may or may not, include wireless functionality, that connects to the device 112e. In this configuration, the network device 112f may utilize or share the wireless functionality provided by the network device 112e to define an interconnected wireless node 114. The network elements or devices 112a to 112f may, in turn, communicate or connect to the first network 102 via, for example, the router 106 and/or an wireless device 126. The wireless device 126 may be a router, a hub or node, a server or any other networkable device in communication with the second wired network portion 124 which, in turn, may be in communication with the first network 102.

The network 100 may further include network elements or devices 116 which may be individually identified by the reference numerals 116a to 116i. The network elements or devices 116a to 116i may be configured or arranged to establish one or more wireless networks or system such as the sub-networks 118a and 118b. The network elements or devices 116a to 116i may be any networkable device such as, for example, servers, terminals, hubs and/or nodes. Alternatively, each of the network elements or devices 110, 112 and 116 may represent another network or system in communication with the network 100. As shown in FIG. 1, the network elements or devices 110, 112 and 116 may be configured to communicate in either a wired or wireless manner with, for example, a wireless router or hub 120, the internet, an intranet or other communication network or system.

The network 100 may be any complex system, process or operation that includes, for example, one or more stakeholders, one or more devices or components and which may be vulnerable to one or more internal and/or external threats. For example, the network 100 may include one or more stakeholders associated with the network devices 112a to 112f. As previously discussed, the network devices 112a to 112f may communicate with the wireless device 126 operable on the second wired network portion 124 of the second network 108. In this configuration, the stakeholders associated with the wireless devices 112a to 112f have a stake in the continued operation of both the wireless device 126 and the second wired network portion 124 of the second network 108. Similarly, the network devices 110a to 110f may be associated with one or more stakeholders. The stakeholders associated with the network devices 110a to 110f may, in turn, have a stake in the continued operation of first wired network portion 122 of the second network 108. In this configuration, the stakeholders associated with both groups of network devices 110 and 112 may have an additional stake in the continued operation and connectivity provided by the router 106 in order to connect to the first network 102.

The sub-networks 118a and 118b and the included network devices 116a to 116i may likewise be associated with one or more stakeholders. The stakeholders associated with the network devices 116a to 116i may have a stake in the continued communications within each of the sub-networks 118a and 118b as well as the wireless router 120 which provides access to the first network 102. Stakeholders associated with the terminals 104 may have a stake in the continued operation of the router 106 and/or the wireless router 120 in order to maintain communications and connectivity with the second network 108 and the sub-networks 118a and 118b.

In this way, the network 100 may be evaluated as a series interconnected processing nodes, data nodes and devices 110, 112, 116, etc. Security requirements may mandate various partitions, e.g., the sub-networks 118a, 118b, of the network 100, for the sake of protection, risk mitigation, and access control. Stakeholders to the network 100, sub-networks 118a, 118b, etc. may be users or user communities, who can be characterized by: (1) the set of nodes or the sub-network or network to which they have access or have a stake; (2) the services that they expect from (their part of) the sub-network or network; and (3) the stakes they have in the delivery of these services.

The same sub-network 118a, 118b, device 110, 112, and 116 may serve more than one user or stakeholder; may deliver different services to different users and stakeholders; and may carry different stakes for different stakeholders. Thus, the network 100 may not be evaluated in a centralized fashion, but rather from individual stakeholder standpoints; each stakeholder defines a specific mission within the enterprise, and attaches specific stakes to accomplishing this mission.

Table 5 illustrates an example of a Stakes matrix that may be assembled or constructed to address one or more exemplary security requirements that may be of interest to the stakeholders on the network 100.

TABLE 5
The stakes matrix showing how Failure Cost (FC) is derived. FC
may be represent as a dollar per unit of time value such as, for example,
dollars per hour ($/hr) or simply as a dollar loss value.

| | | REQUIREMENTS | | |
|---|---|---|---|---|
| STAKES | | | R₂ - Freedom From | R₃ - Protection of Critical |
| MATRIX | | R₁ - Access Control | Insider Threat | Data |
| STAKEHOLDERS | S₁₀₄ | Unable to utilize | Prevents real- | Ensure Validity and |
| | | resource on the | time control and | Safety of Mission |
| | | First and Second | monitoring | Critical Information |
| | | Networks 102, 108 | | |
| | S₁₁₀ | Inability to | Prevents real- | Ensure Validity and |
| | | Communicate with | time control and | Safety of Mission |
| | | the Second | monitoring | Critical Information |
| | | Network 108 | | |
| | S₁₁₂ | Inability to share | Prevents sharing | Secure |
| | | communications | of wireless | Communication of |
| | | resources | capabilities (see | Mission Critical |
| | | | 112e and 112f) | Information |
| | S₁₁₆ | Lack of operability | Effectively | Secure |
| | | within the Sub- | prevents the use | Communication of |
| | | Networks | of the Sub- | Mission Critical |
| | | | Networks | Information |

The exemplary stakes matrix may serve to link and highlight each individual stakeholder's stake or interest in a given security requirement or aspect of the network 100. Individual costs or expenses may be identified and associated with each of the potential failures defined in the stakes matrix. For example, in a case where stakeholder S₁₁₂ cannot share communication resources, as specified by requirement R₁, the lost opportunity cost is determined by the stakeholder S₁₁₂ and assessed and/or added towards the stakeholder's share of the startup/mitigation costs associated with implementation and maintenance of requirement R₁.

TABLE 6
The dependency matrix linking requirement with components.

| | | COMPONENTS | | | |
|---|---|---|---|---|---|
| | | | | Secure | |
| | | Processing | Login | Storage | User Profile |
| | | Component | Component | Component | Analysis |
| DEPENDENCY MATRIX | | C₁₀₄ | C₁₀₆ | C₁₂₀ | C₁₂₆ |
| REQUIREMENTS | R₁ - Access | 0.01 | 0.98 | 0.40 | 0.10 |
| | Control | | | | |
| | R₂ - Freedom | 0.01 | 0.60 | 0.20 | 0.98 |
| | From Insider | | | | |
| | Threats | | | | |
| | R₃ - | 0.01 | 0.20 | 0.98 | 0.20 |
| | Protection of | | | | |
| | Critical Data | | | | |

Table 6 illustrates an exemplary dependency matrix that may be constructed in accordance with the teachings of the present disclosure. The exemplary dependency matrix may serve to link and highlight the specific components (C₁₀₄, C₁₀₆, C₁₂₀ and C₁₂₆) with the individual security requirements that they may affect and/or influence. The probabilities listed in the dependency matrix serve to indicate the degree to which a given component is responsible for providing or satisfying a given requirement.

TABLE 7
The impact matrix showing component failure versus threats
relationship grouping

| | | THREATS | | | | |
|---|---|---|---|---|---|---|
| IMPACT | | T₁ - Insider | T₂ - | T₃ - Denial | T₄ - | |
| MATRIX | | Threat | Intrusions | of Service | Authetication | NO Threat |
| COMPONENTS | C₁₀₄ | 0.20 | 0.40 | 0.80 | 0.80 | 0.00 |
| | C₁₀₆ | 0.20 | 0.20 | 0.20 | 0.20 | 0.00 |
| | C₁₂₀ | 0.20 | 0.40 | 0.20 | 0.20 | 0.00 |
| | C₁₂₆ | 0.20 | 0.10 | 0.10 | 0.10 | 0.00 |

Table 7 provides an exemplary Impact matrix that may be constructed in accordance with the teachings of the present disclosure. The exemplary Impact matrix may serve to link and highlight the specific components (C₁₀₄, C₁₀₆, C₁₂₀ and C₁₂₆) with the individual security threats that may affect and/or disrupt their operation, ability to provide a given service and/or satisfy one or more of the identified security requirements.

Table 7 may be expanded to include additional rows and columns representing any number of components and threats. Some of the components (C₁₀₄, C₁₀₆, C₁₂₀ and C₁₂₆) may not be impacted by a given threat and as such, the entry would be zero or No Threat. Furthermore, some components may not be completely covered by the threats (e.g., row sum <1.0) thereby representing the degree of an Absence of Threat.

The information provided and/or determined via these matrices may, in turn, be analyzed to arrive at an MFC metric. The MFC metric may then be utilized by, for example, a system architect or designer, an automated control or design system, a control system (operating in real-time or in an offline fashion) or other known analysis systems to identify potential vulnerabilities within the network 100. These potential vulnerabilities may, in turn, be targeted by specific V&V efforts or other testing and/or security protocols in order to mitigate and or minimize the vulnerabilities associated therewith.

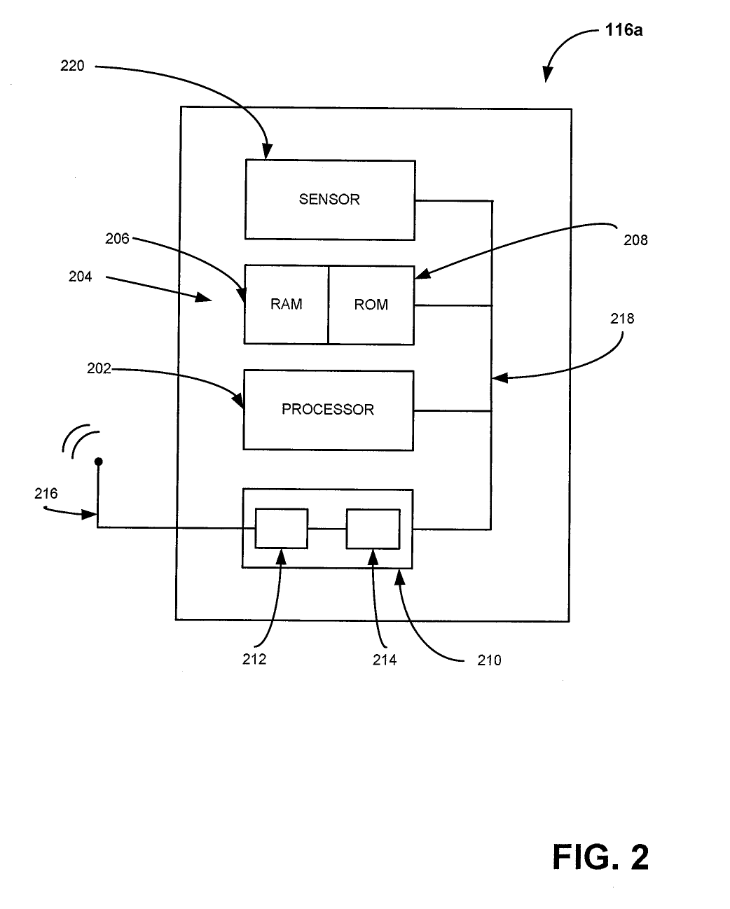

FIG. 2 illustrates an exemplary detailed view of one of the network elements or devices 116a to 116i. In particular, FIG. 2 illustrates the network element or device 116a. The network device 116a in this exemplary embodiment may include a processor 202 such as an INTEL® PENTIUM®, an AMD® ATHLON® or other known processors in communication with a memory 204 or storage medium.

The memory 204 or storage medium may contain random access memory (RAM) 206, flashable or non-flashable read only memory (ROM) 208 and/or a hard disk drive (not shown), or any other known or contemplated storage device or mechanism. In other embodiment, the memory 204 may constitute a database configured to store information related to the disclosed methodology. The network element or device may further include a communication component 210. The communication component 210 may include, for example, the ports, hardware and software necessary to implement wired communications with the control network 100. The communication component 210 may alternatively, or in addition to, contain a wireless transmitter 212 and a receiver 214 (or an integrated transceiver) communicatively coupled to an antenna 216 or other broadcast hardware.

The sub-components 202, 204 and 210 of the exemplary network device 116a may be coupled and configured to share information with each other via a communications bus 218. In this way, computer readable instructions or code such as software or firmware may be stored on the memory 204. The processor 202 may read and execute the computer readable instructions or code via the communications bus 218. The resulting commands, requests and queries may be provided to the communication component 210 for transmission via the transmitter 212 and the antenna 216 to other network elements or devices 110, 112 and 116 operating within the first and second networks 102 and 108. Sub-components 202 to 218 may be discrete components or may be integrated into one (1) or more integrated circuits, multi-chip modules, and/or hybrids.

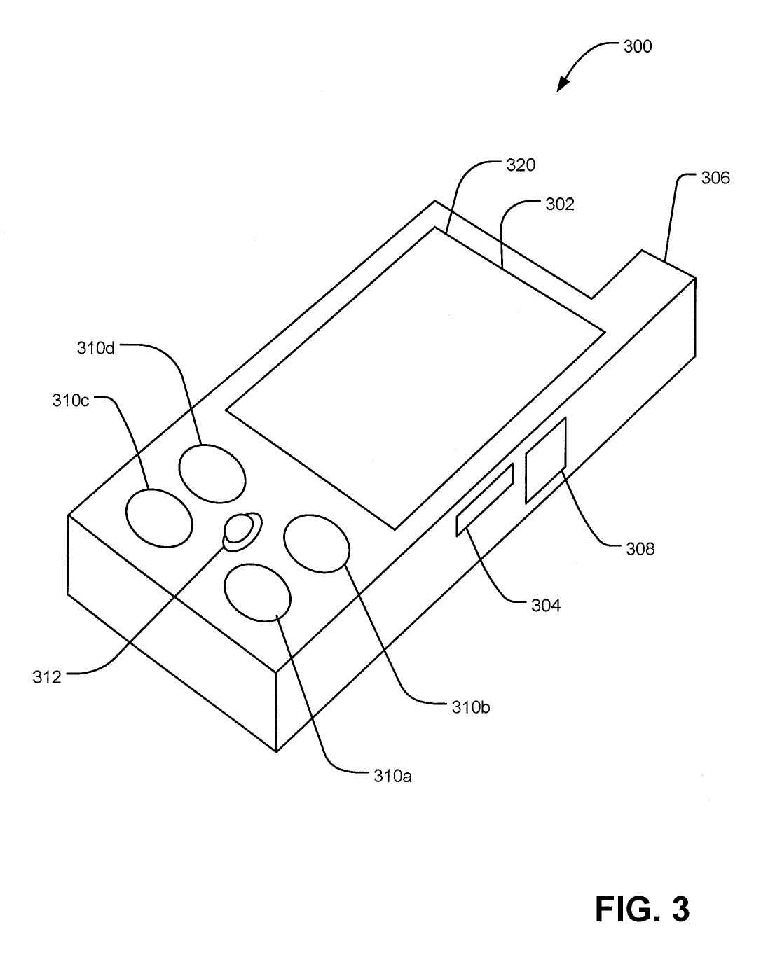

FIG. 3 illustrates an exemplary embodiment of a device or system 300 that may be utilized in cooperation with the one or more of the elements, components, devices 110, 112 and 116 and/or the network 100 as a whole. The device or system 300 may be configured to or execute an econometric control system or schema related to the network 100 and/or each of the devices or elements 110, 112, 116, etc. operable therein.

The device or system 300 may be, for example, a laptop computer, a personal digital assistant (PDA) or smart phone utilizing, for example, Advanced RISC Machine (ARM) architecture or any other system architecture or configuration. The device 300, in this exemplary embodiment, may utilize one or more operating systems (OS) or kernels such as, for example, PALM OS®, MICROSOFT MOBILE®, BLACKBERRY OS®, SYMBIAN OS® and/or an open LINUX™ OS. These or other well known operating systems could allow programmers to create a wide variety of programs, software and/or applications for use with the device 300.

The device 300 may include a touch screen 302 for entering and/or viewing configuration information or data, a memory card slot 304 for data storage and memory expansion. For example, the touch screen 302 may be configured to present or display a graphical user interface (GUI) generated and provided by a processor similar or identical to the processor 202 or one or more of the ASIC devices. The processor may be a single processor tasked with interacting with and/or processing information stored on a memory such as the memory 202. Alternatively, the processor may encompass one or more application-specific integrated circuits (ASIC) configured to, for example, (1) generate and control a user interface; (2) analyze information stored or accessible via the memory; (3) formulate and/or implement a control strategy based on the analyzed information. For example, the memory could store the information necessary to construct the matrices discussed above, the control and analysis code necessary to analyze this information and any other tools or interfaces necessary to implement or evaluate an MFC-based CSES. The user may, in turn, interact with the touch screen 302 to populate the matrices discussed above, review or interact with the MFC-based CSES or any other task necessary to operating and/or controlling the network 100.

The memory card slot 304 may further be utilized with specialized cards and plug-in devices such as, for example, a wireless networking card, to expand the capabilities of functionality of the device 300. The device 300 may include an antenna 306 to facility connectivity via one or more communication protocols such as: WiFi (WLAN); Bluetooth or other personal area network (PAN) standard; cellular communications and/or any other communication standard disclosed herein or foreseeable. The device 300 may further include an infrared (IR) port 308 for communication via the Infrared Data association (IrDA) standard. The device 300 may be configured and designed with a communication component similar to, and compatible with, the communication component 210 shown and discussed in connection with FIG. 2. The communication components utilized within one or more of the network elements or devices and the device 300 may be selected and configured to be inter-compatible and compliant with any one of the communication protocols or standards discussed herein. The device 300 may, in an embodiment, include or incorporate the components, elements and/or functionality deployed within the device shown in FIG. 2.

Hard keys 310a to 310d may be provided to allow direct access to predefined functions or entrance of information via a virtual keyboard provided via the touch screen 302. The number and configuration of the hard keys may be varied to provide, for example, a full QWERTY keyboard, a numeric keyboard or any other desired arrangement. The device 300 may further include a trackball 312, toggle or other navigation input for interaction with emergency information or data presented on the touch screen 302.

The device 300 may be configured to communicate with, for example, the deployed devices 116a to 116i and the router 106, the wireless router or hub 120 and/or the wireless device 126. In this way, the device 300 may implement an econometric control system or scheme and communicate and/or adjust the network devices or systems based on the results of the implementation. In particular, the device 300 may adjust or evaluate each of the devices operating within the network 100 to assist in the design and construction of the system, or may iteratively adjust or evaluate the devices to provide ongoing control and protection of an existing system.

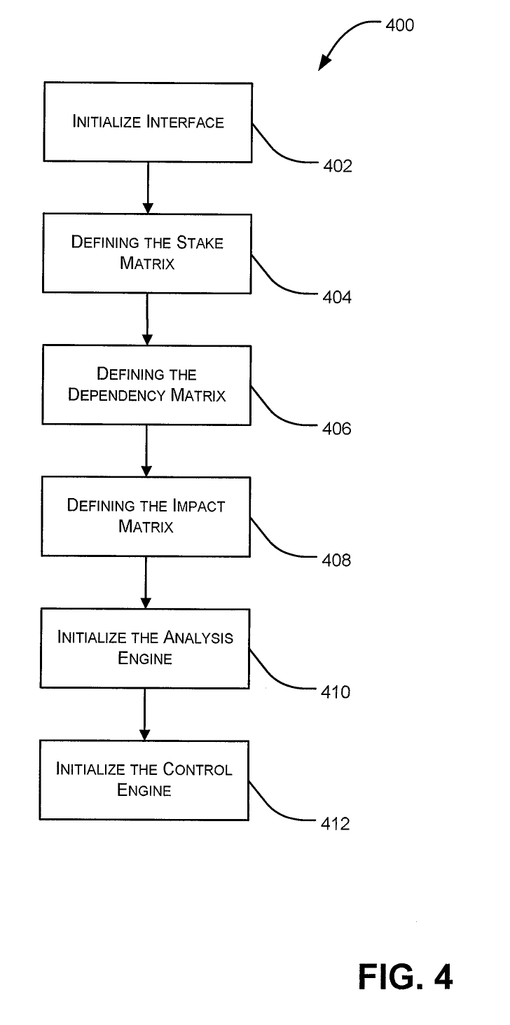

FIG. 4 depict a flowchart 400 that illustrates the steps, tasks and/or methodology that may be utilized or undertaken in connection with an MFC-based CSES. The steps, tasks and/or methodology may be executed on, for example, the device 300, one of the terminals 104 or any other device that may be utilized in connection with the network 100.

At block 402, a processor or ASIC, similar or identical to the processor 202, within the device 300 may initialize an interface engine. The interface engine may be an expert system configured to guide a user through the process of establishing or interfacing with the CSES. Alternatively, or in addition to, the interface engine may be a graphical user interface (GUI) configured for display on the touch screen 302. The GUI may prompt or interact with the use to and guide them through the procedure of setting-up the CSES.

At block 404, the interface engine may prompt or interact with the user(s) to gather stakeholder information related to the stakeholders of the network 100. Moreover, the interface engine may gather information from the user(s) to identify the security specifications or requirements of interest to each of the stakeholders and to be provided by the network 100.

At block 406, the interface engine may prompt or interact with the user(s) to gather component information related to the security specifications or requirements of interest to each of the stakeholders as provided at block 404.

At block 408, the interface engine may prompt or interact with the user(s) and/or may utilize empirically gathered information to gather information regarding the possible threats that may be experience by the network 100. The interface engine may, in turn, be utilized relate the possible threats to the components of the network 100 likely to experience the effects of the threats.

At block 410, the processor or ASIC, similar or identical to the processor 202, within the device 300 may initialize an analysis engine. The analysis engine may utilize the information stored gather at least at blocks 404 to 408 to determine of calculate at least one MFC metric for the network 100.

At block 412, the processor or ASIC, similar or identical to the processor 202, within the device 300 may initialize a control engine. The control engine may utilize at least one MFC metric determined at block 410 to generate a control strategy for the network 100. The control strategy may be implemented in real-time as the network 100 operates or may be generated offline and provided or uploaded to the network 100 during a schedule maintenance cycle or some other convenient period. Alternatively, the control engine may be utilized to provide guidance and/or information to the operators, designers and other interested parties of network 100 toward thwarting or eliminating threats (e.g., data corruption, extrusion, exfiltration, or other misuse including fraud or damage). The guidance or information may be utilized to allocate maintenance such as protective measures and upgrade resources and determine a V&V schedule and priority list for the components operable within the network 100.

The process may run continuously in a real-time analysis and control mode or it may be utilized at discrete time intervals for a spot check and or maintenance. Alternatively, the process illustrated by the flowchart 400 may be utilized as a design tool to aid in the set up and configuration of the network 100 and the selection or identification of the components to be utilized therein.

### V. First Exemplary Utilization of an MFC Metric

In another embodiment, the MFC-based CSES may be utilized to analyze another complex system. For example, CSES may be utilized in connection with a flight control system (FCS) on board a commercial aircraft that includes representative stakeholders, requirements, and stakes (failure costs). In this embodiment, the stakeholders may, for example, include: the aircraft pilot; the passengers; the airline company; the aircraft manufacturer; the FAA; the insurance company that insures the aircraft; and the insurance company that insures a passenger (life insurance). The system specification and/or requirements may, for example, include: adhering to safety requirements (maintaining the aircraft above stalling speed, ensuring never to reverse thrust in mid-air, ensuring landing gears are out before landing, etc); adhering to FAA flight vector; ensuring timely response to autopilot parameter adjustments; maximizing fuel efficiency; minimizing flight delay; ensuring a smooth ride; and minimizing emission of greenhouse gases.

The exemplary Stake Matrix provided in Table 8, illustrates two requirements Safety Record and Timeliness and their corresponding stake as it relates to the various stakeholders identified above.

TABLE 8
Example of the stakes matrix showing requirements. Entries may
be represented as a dollar per unit of time value (or simply as a
dollar loss value) such as, for example, dollar per hour ($/hr) or any
other metric that can be converted to a dollar per unit of time value.

| | REQUIREMENTS | |
|---|---|---|
| STAKEHOLDER | R₁ - SAFETY RECORD | R₂ - TIMELINESS |
| PASSENGERS | Arrive safely | Inconvenience, |
| | | missed opportunities |
| AIRLINE COMPANY | Reputation with passengers | Reputation with |
| | Value 1 | passengers Value 2 |
| AIRCRAFT | Reputation with passengers | Reputation with |
| MANUFACTURER | Value 3 | passengers Value 4 |
| INSURANCE | Premium owed for loss of | Zero |
| RELATED TO | aircraft | |
| AlRCRAFT | | |
| INSURANCE | Value of life insurance | Zero |
| RELATED TO | | |
| PASSENGER | | |

Each of the correlated items within the Stakes matrix may be assigned or associated with a failure cost (FC), as discussed above. The failure cost may be provided by the stakeholder(s) in accordance with their stake in the operation of the flight control system. The failure cost may, for example, be obtained or calculated by an insurer specializing in a particular industry, technology, etc.

The exemplary Dependency matrix illustrates an exemplary interaction between components of an airliner and the requirements with respect to the passenger or stakeholder. The correlated items within the Dependency matrix may be associated with the probability that the component may not satisfy the requirement within a given period of operation of the flight control system.

TABLE 9
Example of the dependency matrix showing requirements and
components with respect to passenger. Columns represent individual
components within the system of interest, and the entries represent the
probably of a system failure as a result of a failure of an individual component
to satisfy a given requirement.

| | COMPONENTS | | | | | |
|---|---|---|---|---|---|---|
| | C_{S1} - Stall/ | | C_{S3} - Pilot | | | C_{T6} - |
| | Angle of | C_{S2} - | Landing | C_{T4} - | C_{T5} - | Reservation |
| | Attack | Thrust | Intent | Departure | Arrival | Monitor and |
| REQUIREMENTS | Governor | Monitor | Monitor | Scheduler | Scheduler | Rescheduler |
| SAFETY (WITH | Stalling | Reverse | Landing | 0.00 | 0.00 | 0.00 |
| RESPECT TO | Speed | thrust in | gears are | | | |
| PASSENGER) | 1.00 | mid-air | not | | | |
| | | 1.00 | deployed | | | |
| | | | prior to | | | |
| | | | landing | | | |
| | | | 1.00 | | | |
| TIMELINESS (WITH | 1.00 | 1.00 | 1.00 | Late | Late | Inability to |
| RESPECT TO | | | | departure | arrival | make |
| PASSENGER) | | | | 0.50 | 0.50 | connections |
| | | | | | | 1.00 |

Similarly, the exemplary Impact matrix illustrates an exemplary interaction between potential threats and components of the flight control system and the requirements with respect to the passenger or stakeholder.

TABLE 10
Example of the impact matrix showing threats with respect to
Components from dependency example with respect to passenger

| | FAULTS/THREATS | | | | | | |
|---|---|---|---|---|---|---|---|
| | | | | T₄ - | T₅ - | T₆ - | |
| | | | | Security | Security | Security | |
| | F₁ - | F₂ - | F₃ - | threat | threat | threat | |
| | Hardware | Software | Communication | type 1: | type 2: | type 3: | No |
| COMPONENTS | failure | failure | failure | insider | intruder | DOS | threat |
| C_{S1} - STALL/ | 0.1 | 0.1 | 0.2 | 0.0 | 0.0 | 0.0 | 0.0 |
| ANGLE OF | | | | | | | |
| ATTACK | | | | | | | |
| GOVERNOR | | | | | | | |
| C_{S2} - | 0.1 | 0.1 | 0.2 | 0.0 | 0.0 | 0.0 | 0.0 |
| THRUST | | | | | | | |
| MONITOR | | | | | | | |
| C_{S3} - PILOT | 0.1 | 0.1 | 0.2 | 0.0 | 0.0 | 0.0 | 0.0 |
| LANDING | | | | | | | |
| INTENT | | | | | | | |
| MONITOR | | | | | | | |
| C_{T4} - | 0.1 | 0.1 | 0.2 | 0.05 | 0.01 | 0.01 | 0.0 |
| DEPARTURE | | | | | | | |
| SCHEDULER | | | | | | | |
| C_{T5} - | 0.1 | 0.1 | 0.2 | 0.05 | 0.01 | 0.01 | 0.0 |
| ARRIVAL | | | | | | | |
| SCHEDULER | | | | | | | |
| C_{T6} - | 0.1 | 0.1 | 0.2 | 0.05 | 0.01 | 0.01 | 0.0 |
| RESERVATION | | | | | | | |
| MONITOR AND | | | | | | | |
| RE- | | | | | | | |
| SCHEDULER | | | | | | | |

The correlated items within the Impact matrix may be associated with the probability that a given threat will cause a failure of a given component of the flight control system.

The information provided and/or determined via these matrices may, in turn, be analyzed to arrive at an MFC metric. The MFC metric may then be utilized by, for example, a flight control system architect or designer, an automated control or design system, a control system (operating in real-time or in an offline fashion) or other known analysis systems to identify potential vulnerabilities within the flight control system. These potential vulnerabilities may, in turn, be targeted to specific V&V efforts or other testing and/or security protocols in order to mitigate and or minimize the vulnerabilities associated therewith.

Additional applications (uses) of MFC may include deciding whether it is worthwhile to perform additional V&V actions (including protective measures) on the enterprise system. Exemplary questions that can be addressed by the MFC include whether the V&V action(s) are worthwhile globally; worthwhile individually by stakeholder; determining how to distribute the cost of V&V actions across the community of stakeholders; and how to quantify the benefits of such actions. Thus, by computing the stakeholder return on investment (ROI) (i.e., investment cost to stakeholder as their contribution to the overall V&V cost and their periodic benefit results as a reduction in MFC), the stakeholder net present value (NPV) may be computed. The sum of all stakeholder's NPV is the global NPV. The global ROI is computed as the global NPV divided by the global V&V cost. In this way, V&V costs can be fairly distributed across the community of stakeholders as either (1) proportional to their respective MFC reduction, or (2) using a strategy that all stakeholder ROI's are identical.

### VI. Second Exemplary Utilization of an MFC Metric

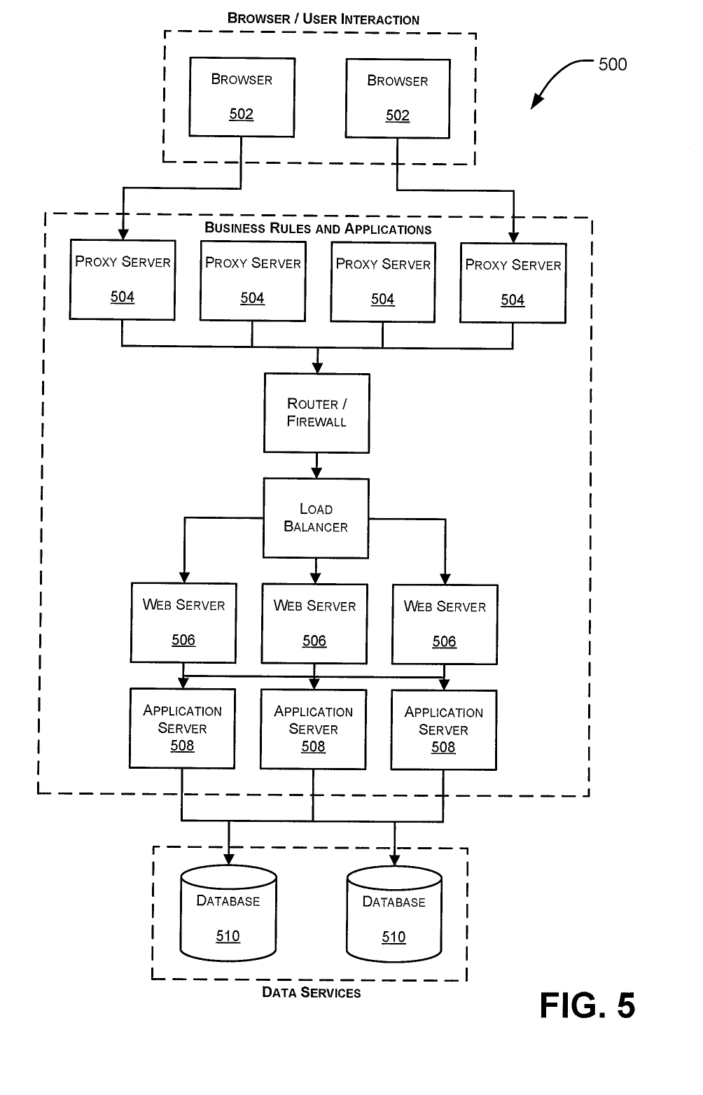

FIG. 5 illustrates an exemplary e-commerce system 500 that may be analyzed utilizing the MFC metric and techniques disclosed herein. In particular, the e-commerce system 500, and properties of the e-commerce system 500, may be evaluated to derive the (3) three matrices of interest.

A. Stakes Matrix

As previously discussed, the first matrix to be constructed and analyzed is the stakes matrix in which the security requirements are identified, and then the stakeholders and their stakes in meeting or satisfying these requirements are determined.

1. Security Requirements

The exemplary e-commerce system 500 may include or otherwise be associated with the following security requirements: (1) Confidentiality to ensure that data is accessible only to authorized users; (2) Integrity to ensure that information that is displayed or transmitted has not been altered by unauthorized parties or users; (3) Availability to ensure that the e-commerce application is operational when a user accesses the system; (4) Non-repudiation to ensure that no party in an operation can deny participating in the operation; (5) Authenticity to ensure that all users or parties in a system are properly authenticated, and their privileges and responsibilities defined accordingly; and (6) Privacy to ensure that information pertaining to system users is not improperly divulged.

2. Stakes and Stakeholders

The exemplary e-commerce system 500 may be accessed or utilized by (4) four stakeholders, namely: (I) the user or customer; (II) the merchant; (III) the technical intermediary, and (IV) the financial intermediary. Each stakeholder has a stake in the satisfaction of the security requirements, and these stakes, in turn, determine corresponding values in the stakes matrix. For example, (I) the user or customer may have a stake in the secure operation of the e-commerce system 500 that may include: the loss of confidential information which the customer may provide during the e-commerce transaction; transaction failure; identity theft. (II) The merchant may have a stake in the secure operation of the e-commerce system 500 that may include: the loss of business that may result from failing the availability requirement; the loss of customer loyalty that may result from failing the availability requirement; the loss of customer loyalty that may result from failing the confidentiality or the privacy requirements; and the loss of business that may result from failing the integrity requirement. (III) The technical intermediary may have a stake in the secure operation of the e-commerce system 500 that may include: the loss of business from the merchant; the loss of reputation for good service which may, in turn, result in lost corporate value. (IV) The financial intermediary may have a stake in the secure operation of the e-commerce system 500 that may include: financial losses that result from malicious activities by customers; the loss of business from the merchant; the loss of reputation for good service which may result in lost corporate value.

Based on a quantification of these stakes in terms of dollars per hours of operation (under the hypothesis that the system fails to meet each security requirement), the stakes matrix shown in Table 11 provides the following relationships:

TABLE 11
An example of a Stakes matrix for the exemplary e-Commerce
system 500 (Stakes in $/Hour)

| | | SECURITY REQUIREMENTS | | | | | |
|---|---|---|---|---|---|---|---|
| | | | | | NON- | | |
| STAKES MATRIX | | CONFIDENTIALITY | INTEGRITY | AVAILABILITY | REPUDIATION | AUTHENTICITY | PRIVACY |
| STAKEHOLDERS | CUSTOMER | 10 | 5 | 3 | 4 | 6 | 12 |
| | MERCHANT | 120 | 70 | 140 | 110 | 105 | 6 |
| | TECHNICAL | 20 | 20 | 40 | 20 | 30 | 20 |
| | INTERMEDIARY | | | | | | |
| | FINANCIAL | 20 | 60 | 50 | 40 | 40 | 60 |
| | INTERMEDIARY | | | | | | |

B. The Dependency Matrix

The second matrix to be constructed and analyzed is the dependency matrix. As previously discussed, the dependency matrix, shown in Table 12, represents how (to what extent) security requirements are dependent on the proper operation of system components. In order to derive this matrix, we must first look at the architecture of the exemplary e-commerce system 500.

1. Web Browser

The end user typically interacts with the exemplary e-commerce system 500 through one or more web browsers 502. Web browsers 502 support user interface modifiability in a wide variety of ways, as the user interface that the browser supports is not hardwired but it is specified via HTML.

2. Proxy Servers

Requests from individual browsers 502 may first arrive at one or more proxy servers 504, which exist to improve the performance of the web-based system. Proxy servers 504 cache frequently accessed web pages so that users may retrieve them without having to access the main web site. However, if a user chooses a particular item, with the intention of bidding or selling, then the user must be shown real-time data. Proxy servers 504 are typically located close to the users, often on the same network, thus saving a tremendous amount of communication and computation resources.

3. Web Servers

HTTP or HTTPS requests received via the web browser 502 are communicated to and received by one or more web servers 506. The web servers 506 are multithreaded, utilizing a pool of threads, each of which can be dispatched to handle an incoming request. Multithreaded web servers 506 are less susceptible to bottlenecks (and hence long latency) when a number of long-running HTTP or HTTPS requests (such as credit card validation) arrive because other threads in the pool are still available to serve incoming requests. This introduces concurrency at the web server level. Upon analyzing the request, the web server 506 sends it to one ore more application servers 508 that respond using the service of one or more databases 510.

4. Application Servers

From the web server the HTTP pr HTTPS requests are forwarded to the application servers 508. These application servers 508 run in the middle business rules and application architecture as illustrated in the figure above. The application servers 508 implement business logic and connectivity, which dictate how clients and servers interact. This allows the databases 510 to concentrate on the storage, retrieval, and analysis of data without worrying about precisely how that data will be used.

5. Database Servers

Finally, the request for service arrives at the database 510, where it is converted into an instruction to add, modify, or retrieve information. The relation database management system (RDBMS) must be able to support all incoming requests from the application servers.

6. Generation of the Dependency Matrix

This section addresses how to estimate the probability that a particular security requirement is violated in the course of operating the e-commerce system 500 for some period of time. The idea that we pursue here is to link the probability of failing a particular requirement with the probability of failure of a component of the system. The elucidation of this probabilistic link involves an analysis of the system's architecture to determine which component contributes to meeting which requirement.

Assuming that components of the same type play interchangeable roles, we do not need to represent individual components in the dependability matrix; it suffices to represent families of components. Hence we must consider the following (families of) components: (a) Browser; (b) Proxy Server; (c) Router/Firewall; (d) Load Balancer; (e) Web Server; (f) Application Server; and (g) Database Server.

Assuming no more than one component fails at a time, and considering the additional event that no component has failed, the dependability matrix has (7+1=)8 columns and 6 rows (one for each security requirement), for a total of 48 entries. We cannot comment on all 48 entries, but will give below a sample of the reasoning that goes into filling the dependability matrix; those values on which we comment are represent in boldface.

TABLE 12
An example of a Dependency matrix for the exemplary
e-commerce system 500

| | | COMPONENTS | | | | | | | |
|---|---|---|---|---|---|---|---|---|---|
| DEPENDENCY | | | PROXY | ROUTER/ | LOAD | WEB | APPL. | DATABASE | NO |
| MATRIX | | BROWSER | SERVER | FIREWALL | BALANCER | SERVER | SERVER | SERVER | FAILURE |
| SECURITY | CONF | 0.2 | 0.2 | 1.0 | 1.0 | 0.333 | 0.333 | 0.5 | 0.0 |
| REQUIREMENTS | INT | 0.2 | 0.2 | 1.0 | 1.0 | 0.333 | 0.333 | 0.0 | 0.0 |
| | AVAIL | 1.0 | 1.0 | 1.0 | 1.0 | 0.333 | 0.333 | 0.0 | 0.0 |
| | NR | 0.2 | 0.2 | 1.0 | 1.0 | 0.333 | 0.333 | 0.0 | 0.0 |
| | AUTH | 0.2 | 0.2 | 1.0 | 1.0 | 0.333 | 0.333 | 0.5 | 0.0 |
| | PRIV | 0.2 | 0.2 | 1.0 | 1.0 | 0.333 | 0.333 | 0.5 | 0.0 |

If no component fails, then (presumably) all security requirements are satisfied. If one of the database components fails, then this does not affect the availability of the system (since according to our hypothesis, the other database server is necessarily operational); loss of a database server may affect response time, but not necessarily availability. Assuming confidential information is stored in only one database (for enhanced protection), then failure of a database server causes a failure with respect to confidentiality, authentication and privacy with probability 0.5. If a Browser fails then availability is not satisfied. If a Proxy server fails, then availability is not satisfied. If the Router/Firewall fails, then no dimension of security is satisfied. If a web server fails then all the dimensions of security have probability 0.33 to fail (all the queries that are routed to that server lead to unpredictable outcomes). If the router is assumed to check when a web server fails, then these probabilities would be 0.0.

C. The Impact Matrix

The third matrix to be constructed and analyzed is the impact matrix. The impact matrix relates component failures to security threats; specifically, it represents the probability of failure of components given that some security threat (from a pre-catalogued set) has materialized. The first step in deriving the impact matrix is, of course, the derivation of the set of threats that we wish to consider; this is akin to defining a fault model (including a set of possible faults) in the analysis of the reliability of a system.

1. Threats on Communication Protocols

This category of threats exploits the weaknesses of the basic protocols of internet such as TCP/IP, HTTP, FTP. The main lines of this type of attacks are: (i) Attacks to make inalienable the server; (ii) The listening of the communications; (iii) The replacement and the manipulation of data; and (iv) The use of the not foreseen protocols or the diversion of protocols.

2. Threats on the Systems and the Standard Applications

This category includes the attacks that exploit the weaknesses at the level of the standard applications of the server. This problem is supported by the standardization of operating systems (UNIX, NT,) and standard applications of communication (SMTP e-mailer, browser using HTTP or still use of SQL for databases). The different possibilities of attacks included in this category are: (i) Attacks on unused or weakly protected network services; (ii) Attacks on the availability of the service by use of application bugs or vulnerabilities; and (iii) Attacks aiming at accessing the computer systems of the company.

3. Threats on the Information

This last type of threats can be used to obtain a profit or even to introduce false information on the site to affect the brand image of the company. We find several forms of attacks there: (i) Attacks in the availability of the site by saturation or manipulation of the information; (ii) Attacks aiming at the illegal appropriation of information on the site; (iii) The hostile modifications of the information displayed on a site to disinform the customers and to compromise the responsibility of the company; and (iv) The modifications of contents of transaction.

4. The Passive Listening

An attack may be initiated via passive listening (or sniffing) communications of a network to try to obtain authentication information such as user login and the password information. The authentication information may be utilized to connect to the server in the place of the real authenticated user.

5. Virus

The infection of the server by a virus can results in its total or partial unavailability. But more serious still is the fact that the server can propagate the virus to system users.

6. Trojan

The Trojan horse, also known as trojan, in the context of computing and software, describes a class of computer threats that appears to perform a desirable function but in fact performs undisclosed malicious functions that allow unauthorized access to the host machine, giving them the ability to save their files on the user's computer or even watch the user's screen and control the computer. Trojan horse payloads are almost always designed to cause harm, but can also be harmless. They are classified based on how they breach and damage systems. The six main types of Trojan horse payloads are: (a) Remote Access; (b) Data Destruction; (c) Downloader/dropper; (d) Server Trojan (Proxy, FTP, IRC, Email, HTTP/HTTPS, etc.); (e) Disable security software; and (f) Denial-of-service attack (DoS).

7. Denial-of-Service and DDoS

A denial-of-service attack (DoS attack) or distributed denial-of-service attack (DDoS attack) is an attempt to render a computer resource unavailable. A DoS attack can be perpetrated in a number of ways. The five basic types of attack are: (i) Consumption of computational resources, such as bandwidth, disk space, or processor time; (ii) Disruption of configuration information such as routing information; (iii) Disruption of state information, such as unsolicited resetting of TCP sessions; (iv) Disruption of physical network components; and (v) Obstructing the communication media between the intended users and the victim so that they can no longer communicate adequately.

8. Threats on the Database

One of the possible attacks has for principle to modify indirectly the SQL orders sent to the server, by including special character strings instead of the parameters there waited by the application software. This technique allows for the retrieval of confidential information from the database. We can make for example a normal call and we shall have in the bar of address of the browser: http://server/prog?User=name_user. We can then make a call falsified by the type: http://server/prog?User=other_user. Utilizing this technique, either information concerning the other user may be directly obtained, or an error which provides indications which allows an intruder to learn, for example, that the name to use is a parameter identifying a matrix and that there is a matrix of user.

9. Generating the Impact Matrix

Given that we have cataloged 8 security threats, the impact matrix shown in Table 13 will have 9 columns, one for each threat plus 1 for the absence of threats. On the other hand, it has 8 rows, 1 for each component plus one for the event that no component has failed during the unitary time period. This gives a total of 72 entries; we will comment on some of them, which we will represent in the table below by boldface figures.

TABLE 13
Impact matrix for the exemplary e-commerce system 500

| IMPACT | | THREATS | | | | | | | | |
|---|---|---|---|---|---|---|---|---|---|---|
| MATRIX | | COMM | SYS | INFO | LIST | VIRUS | TROJ | DOS | DB | NOT |
| COMPONENTS | BRWS | 0.0 | 0.1 | 0.1 | 0.1 | 0.3 | 0.4 | 0.2 | 0.0 | 0.0 |
| | PROX | 0.5 | 0.1 | 0.1 | 0.3 | 0.3 | 0.4 | 0.2 | 0.0 | 0.0 |
| | R/FW | 0.5 | 0.1 | 0.1 | 0.3 | 0.3 | 0.4 | 0.6 | 0.0 | 0.0 |
| | LB | 0.0 | 0.1 | 0.1 | 0.1 | 0.3 | 0.4 | 0.6 | 0.0 | 0.0 |
| | WS | 0.0 | 0.6 | 0.6 | 0.2 | 0.3 | 0.4 | 0.2 | 0.0 | 0.0 |
| | AS | 0.0 | 0.1 | 0.1 | 0.1 | 0.3 | 0.4 | 0.2 | 0.0 | 0.0 |
| | DBS | 0.0 | 0.1 | 0.1 | 0.0 | 0.5 | 0.6 | 0.3 | 0.8 | 0.0 |
| | NOF | 0.4 | 0.3 | 0.1 | 0.1 | 0.05 | 0.05 | 0.1 | 0.2 | 1.0 |

The absence of threats does not cause the failure of any component, and leads to event NoF (No Failure) with probability 1.0. We estimate that threats to the database cause a failure of the database with probability 0.8, say, to make provisions for the case where an attack fails to achieve its goal; they may cause event NoF (No Failure) with probability 0.2. We assume that because the database component is the only target of this threat, the probability that it causes a failure of any other component is 0.0. Generally, the row labeled NoF represents the probability of failure of each threat, i.e., the probability that it does not cause any component to fail. The threat on communication protocol (Comm) targets the proxy servers and the routers; we assume that the probability that it causes a failure of the other components is 0.0. A virus has some likelihood of affecting any component of the system, through propagation. A Trojan horse has some likelihood of targeting any component of the system, through propagation. The threat passive listening targets primarily the components that are involved with communication. The denial of service attacks (DoS) may target the bottlenecks of the architecture, for maximal effect.

D. Threat Configuration

Vector PT characterizes the threat situation by assigning to each category of threats, shown in Table 14, the probability that this threat will materialize over a unitary period of operation (say, an hour). We assume that no more than one threat can materialize within a unitary period of time, and we make provisions for the case where no threat does materialize. Hence this vector contains a probability distribution of complementary events. We assume that in light of log data, known vulnerabilities, and known perpetrator behavior, we have determined that the threats have the probability indicated below.

TABLE 14
Threat Matrix shows
the probability that a threat will
materialize during a given period

| | |
|---|---|
| THREAT | |
| PROBABILITY (PT) | PROBABILITY |

| | | |
|---|---|---|
| THREATS | Comm | 0.01 |
| | Sys | 0.02 |
| | Info | 0.01 |
| | List | 0.01 |
| | Virus | 0.03 |
| | Troj | 0.06 |
| | DoS | 0.03 |
| | DB | 0.02 |
| | NoT | 0.81 |

Using this data, we now compute the vector of mean failure costs, using the formula

MFC=ST∘DP∘IM∘PT.

Substituting each matrix by its value, we find:

| | MEAN FAILURE COST |
|---|---|
| STAKEHOLDERS | $/HOUR |
| CUSTOMER | $7.02 |
| MERCHANT | $112.97 |
| TECHNICAL | $31.16 |
| INTERMEDIARY | |
| FINANCIAL | $51.27 |
| INTERMEDIARY | |

E. Return on Investment

From the standpoint of each stakeholder, the mean failure cost (which is the cost we expect to incur as a result of the lack of security) must be balanced against the cost of improving system security. The mean failure cost (MFC) model allows for the determination of the tradeoff of quality versus cost in terms of a return on investment equation. Specifically, a return on investment (ROI) model is defined by the following parameters:

An initial investment cost, say IC,

An investment cycle (duration), say T,

An return over the investment cycle, say B(t), for 1≦t≦T, and

A discount rate, say d.

Then the return on investment is given by the following formula:

$$R O I = - 1 + {\sum }_{t = 1}^{T} \frac{B ( t )}{I C \times {( 1 + d )}^{t}}$$

In this example illustrates the application of the CSES/MFC model for estimating system security. The quantification of security attributes by means of costs to stakeholders opens a wide range of possibilities for further economics based analysis, and provides a valuable resource for rational decision making; our future plans call for exploring such opportunities.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A device for implementing an econometrics-based control system, the device comprising:
a processor;
a memory in communication with the processor, the memory configured to store processor implementable instructions, wherein the processor implementable instructions are programmed to:
generate a stakes matrix to determine a stake at least one stakeholder has in at least one system requirements;
generate a dependency matrix to link a status of at least one component with each of the at least one system requirements;
generate an impact matrix to link a possible threat with each of the at least one components;
determine a mean failure cost as a function of the generated matrices;
analyze the mean failure cost to determine a control strategy; and
a communication component in communication with the processor and the memory, the communication component configured to communicate the control strategy to a component operable within the control system, wherein the component implements the control strategy.

2. The device of claim 1, wherein the processor implementable instructions are further programmed to:
generate a mitigation matrix to link each of the at least one system requirements with a mitigation cost associated with each of the at least one components.

3. The device of claim 1, wherein the processor implementable instructions are further programmed to:
initialize an interface engine configured to system information related to the generated matrices.

4. The device of claim 1, wherein the control strategy includes a resource allocation schedule.

5. The device of claim 1, wherein the impact matrix is generated as a function of empirical data gathered over a fixed period.

6. A method for implementing an econometrics-based control system, the method comprising:
generating a stakes matrix to determine a stake at least one stakeholder has in at least one system requirements;
generating a dependency matrix to link a status of at least one component with each of the at least one system requirements;
generating an impact matrix to link a possible threat with each of the at least one components;
determining a mean failure cost as a function of the generated matrices;
analyzing the mean failure cost to determine a control strategy; and
communicating the control strategy to a component operable within the control system, wherein the component implements the control strategy.

7. The method of claim 6 further comprising:
generating a mitigation matrix to link each of the at least one system requirements with a mitigation cost associated with each of the at least one components.

8. The method of claim 6 further comprising:
initializing an interface engine configured to system information related to the generated matrices.

9. The method of claim 6, wherein the control strategy includes a resource allocation schedule.

10. The method of claim 6, wherein the impact matrix is generated as a function of empirical data gathered over a fixed period.

11. A device for implementing an econometrics-based control system, the device comprising:
a processor;
a memory in communication with the processor, the memory configured to store processor implementable instructions, wherein the processor implementable instructions are programmed to:
correlate a plurality of system requirements with each of a plurality of system stakeholders;
identify a stake relating to each of the plurality of system stakeholders and the correlated plurality of system requirements, wherein the stake is identified by each of the plurality of system stakeholders;
determine a mean failure cost as a function of the identified stake and a failure probability;
analyze the mean failure cost to determine a control strategy; and
a communication component in communication with the processor and the memory, the communication component configured to communicate the control strategy to a component operable within the control system, wherein the component implements the control strategy.

12. A method of implementing an econometrics-based control system, the method comprising:
identifying a plurality of system requirements;
identifying a plurality of system stakeholders;
defining a stake related to the interest of each of the plurality of system stakeholders in one of the plurality of system requirements;
correlating the plurality of system requirements with each of the plurality of system stakeholders;
assigning a failure probability to each of the identified plurality of system requirements;
determining a mean failure cost as a function of the identified stake and the failure probability;
analyzing the mean failure cost to determine a control strategy; and
communicating the control strategy to a component operable within the control system, wherein the component implements the control strategy.
